(19) United States
(12) Patent Application Publication
(10) Pub. No.: US 2018/0030956 A1
(43) Pub. Date: Feb. 1, 2018

(54) Fluid Turbine with Control System

(71) Applicant: Vijay Rao, Westport, CT (US)

(72) Inventor: Vijay Rao, Westport, CT (US)

(21) Appl. No.: 15/729,459

(22) Filed: Oct. 10, 2017

Related U.S. Application Data
(63) Continuation-in-part of application No. 14/614,663, filed on Feb. 5, 2015.

(51) Int. Cl. F03D 7/06; F03D 9/25; F03D 17/00; F03D 3/00

(52) U.S. Cl. CPC F03D 7/06; F03D 3/005; F03D 9/25; F03D 17/00; F05B 2270/602

(57) ABSTRACT

A vertical axis fluid turbine for mechanical and electrical power generation is disclosed. The turbine is comprised of at least three camber-less symmetrical foils rotating about a main axis. Each foil is capable of independent rotation about its own respective axis. A closed loop feedback control system orients the foils to consistently maintain a forward edge into the flow of the fluid. Each foil generates lift in the forward and rearward arcs of rotation, while minimizing drag.

### CROSS-REFERENCE TO RELATED APPLICATIONS

This application is a continuation-in-part of U.S. application Ser. No. 14/614,663, filed on Feb. 5, 2015.

### BACKGROUND

### Technical Field

The present invention is directed to alternative energy power generation and control systems, converting fluid energy into mechanical and electrical power.

### Background Art

Wind turbines have aided humans with power generation for thousands of years. There are two basic categories, horizontal axis and vertical axis. Horizontal axis wind turbines, currently use blades oriented around a hub, similar to airplane propellers, and turn a horizontal axis,

Vertical axis wind turbines utilize vertically oriented blades, which rotate around a vertical axis. They are beneficial over horizontal axis wind turbines in that they do not need repositioning with changing wind direction.

There are multiple types of vertical axis wind turbines. One popular model is the Savonius type (U.S. Pat. No. 1,766,765), which is made up of multiple hollow-shaped vanes rotating around a central axis. The vanes are shaped like scoops, with the concave side catching wind, and the convex side pushing into the wind. The drag differential is inefficient, but effective at rotating the turbine.

Another popular model is the Darrieus type (U.S. Pat. No. 1,835,013). Its blades connect at the top and bottom of a central vertical shaft, and bow out in the middle to resemble an eggbeater. It is slow to start because the angle of attack of each blade is fixed, and typically requires an external force to begin rotation. Similar to the Darrieus, is the Giromill, which has straight vertical blades connected to the central axis by armatures. The blades are also fixed, necessitating an external starting force. Since both the Darrieus and Giromill turbines' blades maintain a fixed orientation, their angles of attack vary depending on their orientation to the wind direction. This inherently creates drag, detracting from the efficiency of the generator, but also creating an uneven dynamic stress on the turbine in the wind's direction.

Some vertical axis wind turbine designs have attempted to overcome the issues of fixed blades. One solution, proposed by Whinney (U.S. Ser. No. 14/646,897), is to mechanically adjust the pitch and camber of the blades as they rotate. This might have some effect on the degree of drag when the blades’ angles of attack are leeward, but the trailing edge of each blade is still forced into the wind, creating inordinate drag on the turbine.

Another proposed solution to the vertical axis wind turbine drag issue, Lundhild (U.S. Ser. No. 14/245,591), utilizes an electronic means of reorienting the blades as they rotate about the axis. This configuration is flawed in that it emphasizes the use of drag for generating power, whereas other aerodynamic forces are more efficient and less strenuous on the turbine.

A vertical axis wind turbine that minimizes drag and utilizes more efficient aerodynamic forces would be an advantageous improvement over the current and proposed designs of others.

### BRIEF SUMMARY OF THE INVENTION

The invention is a vertical axis power generator. The generator converts energy from any moving fluid into mechanical energy, then to electrical energy. The embodiments of the invention described below concern the utilization of wind, but other moving fluids are also envisioned, including underwater embodiments.

One embodiment of the invention includes three vertical airfoils rotating around a vertical main axis. A means for measuring wind direction provides input for orienting each airfoil with its desired angle of attack.

The cross-section of each airfoil is symmetrical in shape, with no camber. An airfoil axle runs vertically through the center of lift for each airfoil. In one embodiment, each airfoil axle connects to a set of armatures which rotate about the main axle. The airfoil axles afford three hundred and sixty degree rotation of each airfoil about its respective axis. Each airfoil axle also comprises a means of rotating the airfoil about its respective airfoil axle, and a means of measuring the rotational position of the airfoil.

The symmetry of each airfoil allows it to generate lift on either face, depending on its angle of attack to the wind direction. An angle of attack parallel to the wind direction will generate no lift in either direction.

Airfoils rotate about their respective airfoil axes as the armatures rotate about the main axle. The rotation of the armatures about the main axle is called an orbit. As the armatures orbit the main axle, each airfoil rotates about its respective airfoil axle to produce a desired angle of attack. The airfoils are not mechanically bound to each other, enabling them to have differing angles of attack. Motors adjust the angles of attack for each airfoil, facilitating the ability of each airfoil to continually generate lift at different positions in the orbit.

As airfoils orbit the main axle, the angle of attack reverses from the most windward position of the orbit to the most leeward position. The symmetry of each airfoil affords the ability to generate effective torque at both the windward and leeward arcs of the orbit.

As airfoils move between windward and leeward sides of the orbit, they pass through a transition zone, with an angle of attack parallel to the wind direction,

In one embodiment, the main axle rotates a generator, converting the mechanical forces of the main axis into electricity.

### BRIEF DESCRIPTION OF THE DRAWINGS

FIG. 1 is a perspective view of one embodiment of the invention;

FIG. 2 is a front view and a cross-sectional view of one airfoil;

FIG. 3 shows three cross-sectional views of an airfoil at differing angles of attack;

FIG. 4 is a diagram representing one embodiment of the invention showing three airfoils in stopped mode;

FIG. 5 shows four diagrams of one embodiment of the invention, with three airfoils at differing positions in an orbit;

FIG. 6 is a diagram showing the rotation of an airfoil as it completes an orbit; and

FIG. 7 is a chart showing the flow of information in the control system.

### DETAILED DESCRIPTION OF THE INVENTION

The invention is a vertical axis power generator and its control system. This application will primarily discuss one embodiment of the invention, which converts wind energy into electric power, but other embodiments harnessing the power of other moving fluids are envisioned, specifically water.

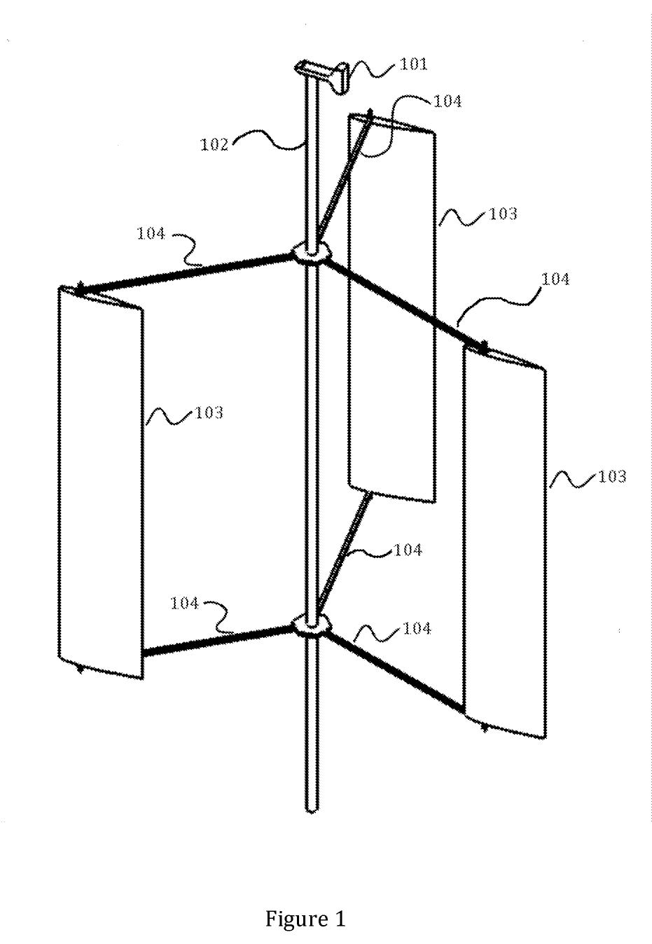

One embodiment of the invention is a vertical axis wind turbine with three foils. See FIG. 1. Other embodiments of the invention may contain more than three airfoils. The invention includes a means for constantly measuring wind direction. In this embodiment, a wind vane 101 is attached to the top of a central shaft 102. A rotary encoder measures the rotational position of the wind vane. For power generation based on wind, the foils are airfoils. Alternative embodiments which use water as the moving fluid have hydrofoils.

The three airfoils 103 are attached to the central shaft by three sets of armatures 104. The armatures rotate in a clockwise or counterclockwise direction about the central shaft. Other embodiments may provide an alternate means of connecting the airfoils and rotating them about a central axis, with examples including the exchanging of armatures for rotating plates or placing airfoils in a hollow bodied cylinder.

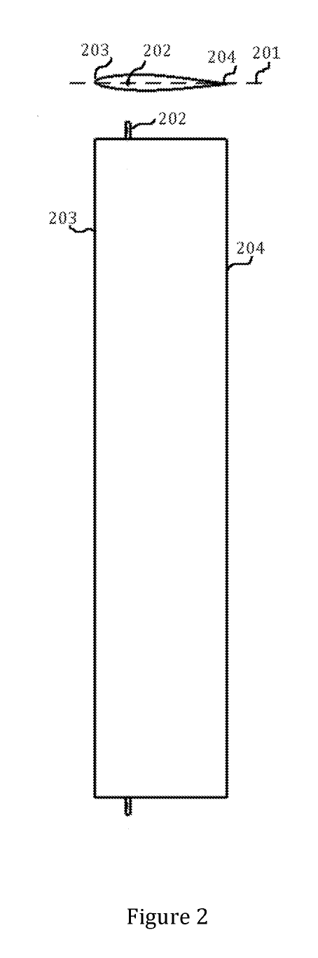

FIG. 2 shows the front view of one embodiment of an airfoil and its cross section. Each airfoil is symmetrical along the chord line 201. The airfoils are not cambered, providing the ability to generate equal lift from either face. Each airfoil has an airfoil axle 202 running vertically through its aerodynamic center, or center of lit The airfoils' general thickness and positioning of max thickness are variable depending on the specific location and application of the invention, but the airfoils must have a leading edge 203 and a trailing edge 204.

The invention has a means for rotating the airfoils a full three hundred and sixty degrees about their respective airfoil axles, and a means of measuring each airfoil's rotation. One embodiment uses a motor to rotate each airfoil and a rotary encoder to measure the rotation of each airfoil with respect to a home position. Some embodiments of the invention may use servo motors or stepper motors for the motors, and absolute rotary encoders or rotary encoders coupled with a home sensor.

Positioning the airfoil axes at the aerodynamic centers is important for two reasons. First, it maximizes the translation of forces from the airfoil to the axle. These forces are then translated through the armatures to the main axle and the electric generator. Second, it minimizes the power required to rotate an airfoil about the axle in prevailing wind conditions. The aerodynamic center of an airfoil is neutral with respect to torques acting upon the airfoil, they sum to zero at this point. Theoretically, zero force is required to rotate an airfoil about the axle. In practice, a small force is required to overcome friction.

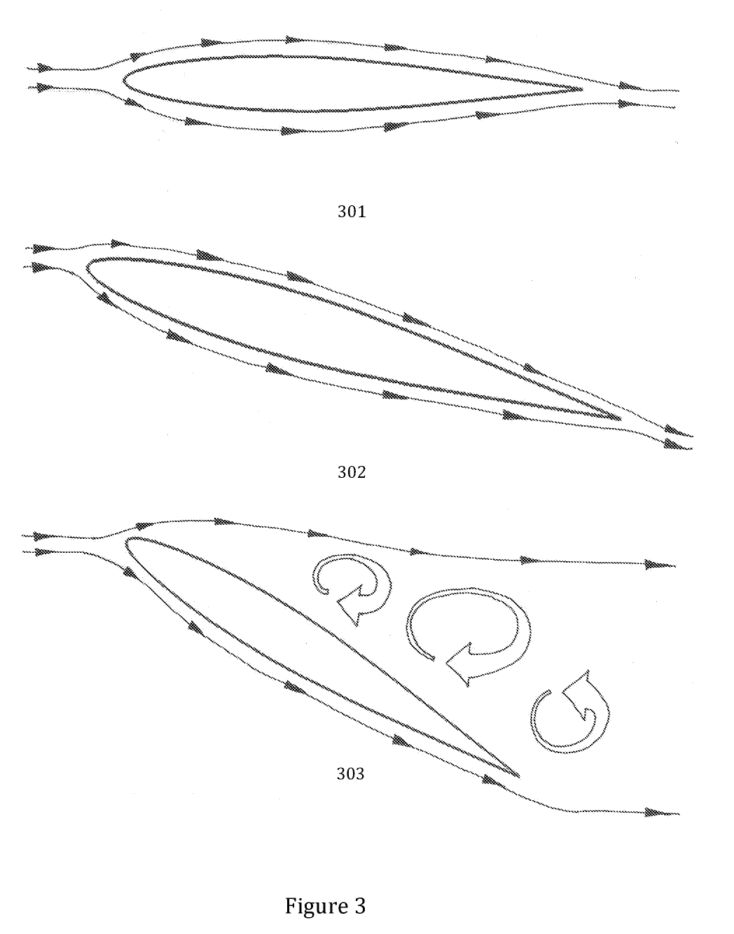

It is necessary to rotate each airfoil independently and continuously, to achieve desired angles of attack at all points in an orbit. FIG. 3 shows three cross sections of airfoils with differing angles of attack to the wind direction.

One cross section 301, shows an airfoil with a zero-degree angle of attack. At this position, the airfoil is not generating any net aerodynamic forces up or down. This is a stopped position.

The second cross section 302 shows an airfoil at an optimal angle of attack. Optimal angles of attack are dependent on multiple conditions, including wind speed, airfoil material, and desired power generation. An angle of attack may be considered optimal if it maximizes desired power generation in certain circumstances, and optimal angles of attack may change with time in a single embodiment of the invention.

With respect to FIG. 3, this airfoil 302 is generating a vertical aerodynamic force, commonly referred to as lift. As air flows across the top face of the airfoil, the Coanda effect attracts air above the airfoil down into the stream of air across the surface. This effect creates a downward flow of air into the airfoil and across its surface to the trailing edge. The downward flow of air creates suction and pulls the airfoil up, producing a vertical force on the airfoil. As the air travels across the surface it is compressed and angled out in the direction of the trailing edge.

Air also travels across the bottom face of the airfoil, but at a lesser speed. The angle of attack provides a longer distance for air to travel across the top than the bottom. The faster moving air on top of the airfoil creates a pressure differential in that direction, a net force upward.

The shape and angle of attack of the airfoil utilizes lift, not drag, to generate power. The aerodynamic effect on the airfoils works in any orientation. Since the airfoils are vertically positioned in a wind turbine, the “lift” generated is a horizontal aerodynamic force.

The third cross section 303 shows an airfoil at an angle of attack too steep for practical purposes. The airfoil will generate lift, but at the cost of massively induced drag 304. This hinders the efficiency of the turbine, but also adds stresses that limit the life of the turbine and increase maintenance costs. It is important to maintain angles of attack that generate lift forces and minimize drag.

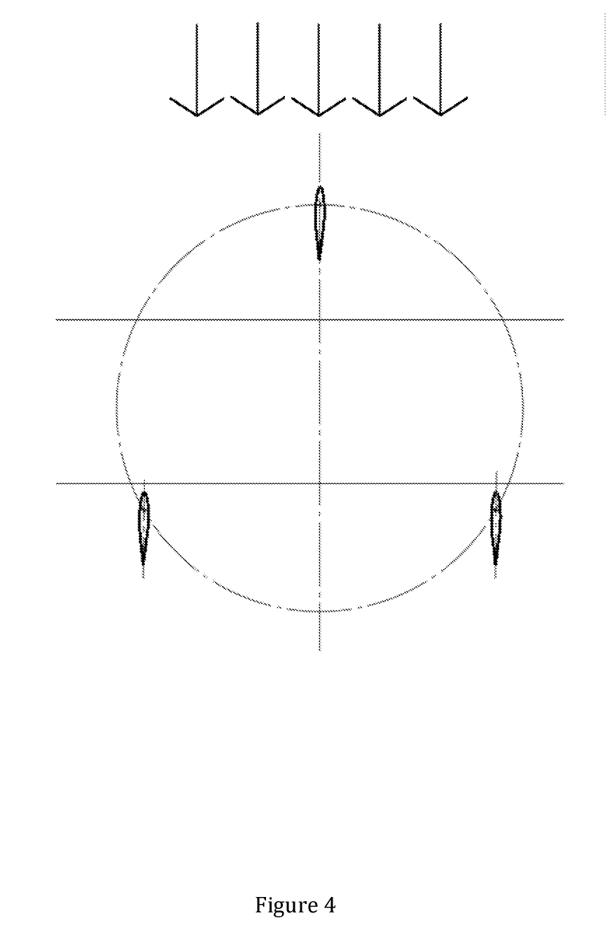

The invention has a stopped mode, where no power is generated. See FIG. 4. This diagram shows a three-airfoil turbine in the stopped mode. The airfoils are oriented parallel to the direction of the wind, with zero-degree angles of attack. At this position, none of the airfoils generate lift in any direction, regardless of the wind speed. A stopped mode is useful when wind speeds are too high, wind direction is erratic, power generation is not needed, or when servicing/maintenance is required.

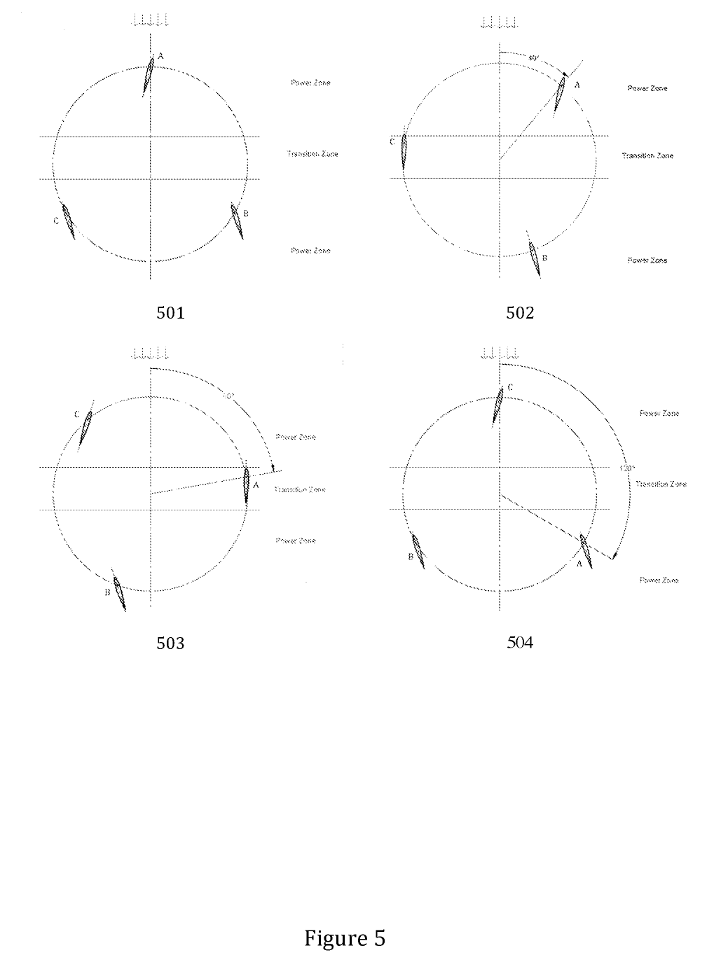

During power generation, each airfoil orbits around the main axle in a complete circle. See FIG. 5 for diagrams showing power generation in a clockwise orbit. The turbine may orbit clockwise or counter-clockwise depending on the preference of the operator, and alternating orbit direction may be desired to prevent uneven wear on the turbine over time.

To begin power generation, the servo motors rotate each airfoil to a desired angle of attack depending on its position in the orbit. For example, Airfoil A is angled to an optimal positive angle, and Airfoils B and C are angled to an optimal negative angle. These angles will generate aerodynamic forces in a clockwise rotation about the main axle. Airfoil A will push the turbine to the right, and airfoils B and C will push generally to the left, 501.

As the turbine armatures rotate clockwise 502, the servo motors continuously adjust the angles of attack so that each individual airfoil contributes to the rotational forces desired. As the airfoils orbit forty degrees clockwise, the angles of attack are adjusted accordingly. Airfoil A is still at an optimal angle of attack to the wind. Since it has orbited forty degrees clockwise, Airfoil A has rotated forty degrees counterclockwise on its respective airfoil axle. Airfoil B has also orbited forty degrees clockwise, and rotated forty degrees counterclockwise on its airfoil axle. Airfoils orbiting at the top and bottom arcs are in power zones, where the most aerodynamic forces are generated. The power zone across the top arc is the forward power zone, or windward power zone for embodiments using wind as the moving fluid. The power zone across the bottom arc is the leeward power zone.

Airfoil C has orbited forty degrees clockwise and entered the transition zone. The airfoils maintain optimal angles of attack in the windward and leeward power zones. Airfoils in the transition zone are moving between optimal windward and leeward angles of attack. If an orbit represents a dock face, the angle of attack at three o'clock and nine o'clock is zero, where the airfoils generate no aerodynamic forces in either direction. The size of transition zones is variable depending on the speed of the orbit and the power of the rotary motors on each airfoil axle. If the orbit is relatively fast, the transition zone will widen, to accommodate the additional time necessary to angle the airfoils to zero degrees at three o'clock and nine o'clock, and then angle them to the windward or leeward optimal angles of attack for the continuing orbit. If the orbit is relatively slow, the transition zones will narrow. Orbits may speed up or slow down depending on wind speed and desired power generation.

In FIG. 5, the airfoils continue to orbit clockwise 80 degrees 503, and then 120 degrees 504. As the turbine orbits 120 degrees, the angles of attack in a three-airfoil embodiment are the same as at start up 501.

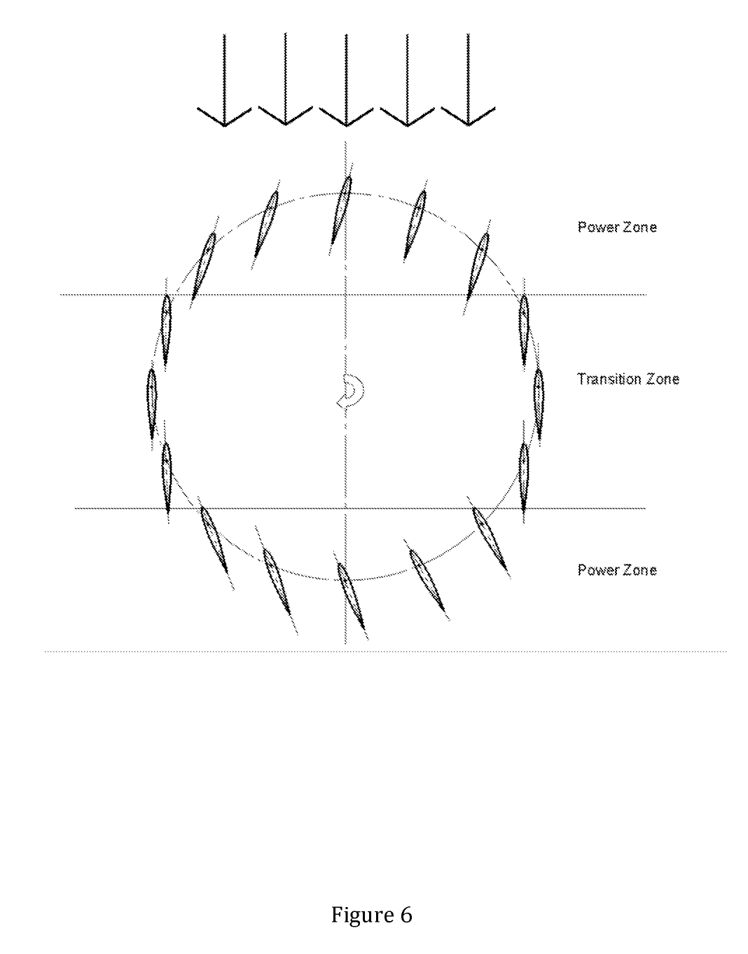

Each airfoil completes a full orbit in the same manner as all other airfoils in the turbine. See FIG. 6 for a diagram of one airfoil orbiting clockwise. The airfoil transitions from its optimal windward angle of attack in the windward power zone, to a zero-degree angle of attack in the three o'clock transition zone, to its optimal leeward angle of attack in the leeward power zone, to a zero-degree angle of attack in the nine o'clock transition zone, and then back to its windward optimal angle of attack again in the windward power zone.

The importance of symmetrical airfoils is demonstrated here, because one face of the airfoil will be windward in the windward power zone but then leeward in the leeward power zone. The symmetry of the airfoil affords the ability to generate torque on the turbine in both power zones, regardless of which face of the airfoil is windward.

As the airfoils orbit the turbine, the armatures rotate in kind. The armatures turn the main axle connected to a power generator, creating electricity. There is a power expenditure by each servo motor to reorient the airfoils' angles of attack throughout the orbit. Since the airfoil axles are positioned at the aerodynamic centers of each airfoil, the power expenditure is minimal.

The optimal angles of attack may increase or decrease during power generation, depending on changing conditions and desired power generation. To stop the turbine, the angles of attack for each airfoil rotate to zero degrees. The turbine will retain some momentum and continue orbiting while maintaining angles of attack in parallel with the wind direction. The generator will provide resistance to the main axle and slow the turbine to a stopped position. See FIG. 4.

The invention includes a closed loop control system. Electronic controls are required to continuously position the airfoils at desired angles of attack to eliminate drag and stress on the turbine. A mechanical system inherently fads this task, as it will consistently position airfoil trailing edges into the wind. The present invention maintains airfoil position such that the trailing edge of each airfoil is always leeward.

The control system is comprised of several sensors providing feedback for operation. Data on wind direction, orbital speed and power generation are necessary. Standard computer components include a processor, memory, data storage, power source, and wiring from motors and rotary encoders.

Primary sensors include rotary encoders on the wind vane, main axle, and each airfoil. The rotary encoder on the wind vane continuously monitors wind direction, which is subject to change instantaneously during power generation or more broadly on a daily or seasonal basis. Wind direction provides the basis for calculating the angle of attack.

A rotary encoder on the main axle provides information on the speed and position of orbital rotation of the turbine. As demonstrated in FIG. 5, when an airfoil orbits the main axle, the airfoil rotates proportionally in an opposite direction about its respective airfoil axle. Orbital rotation position is calculated relative to the current wind direction. Some embodiments of the invention have a wind vane mounted directly on the main axle, and a single rotary encoder can calculate the orbital rotation of the turbine as a function of the wind direction. Other embodiments have separate means of calculating wind direction and orbital rotation.

Orbital speed is monitored to maintain safe operating conditions. If the orbital speed is too fast, the optimal angle of attack is reduced to lower the speed.

Rotary encoders on each airfoil provide data on the current airfoil position relative to a home position. As the turbine orbits, a desired airfoil position is calculated using the wind direction and orbital rotation. Signals are continuously sent to each airfoil's servo motor, rotating the airfoil to the desired position.

Additionally, the generator provides feedback information on the amount of power being generated and the total energy capacity of the turbine. Generators have an upper limit capacity, and they may provide resistance to orbital rotation in some embodiments. Desired power generation is the driving metric of the control system, and angles of attack may change to increase or decrease power generation. If power generation is overloading the generator, a signal to decrease or stop rotation is sent.

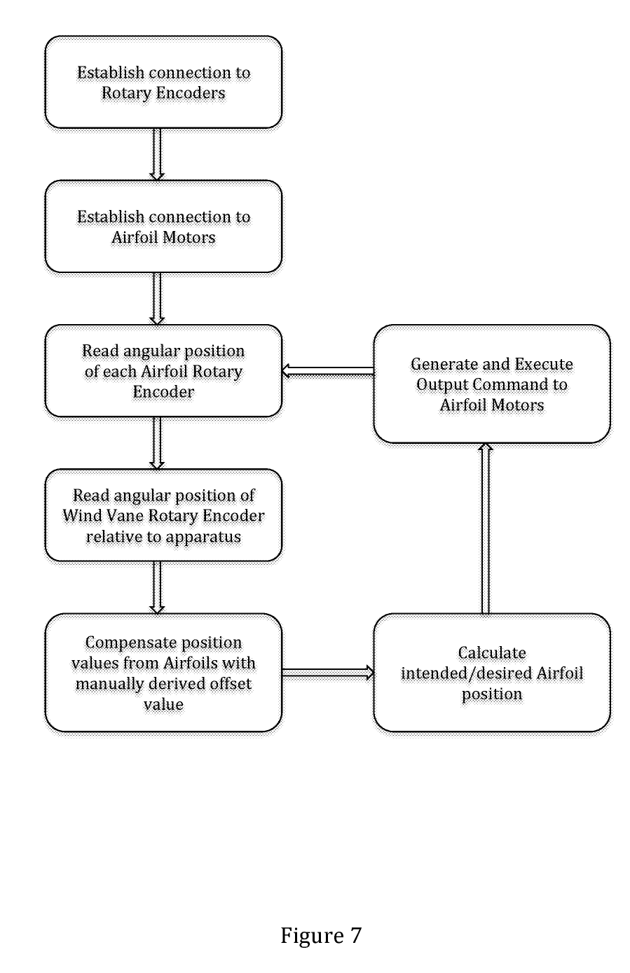

FIG. 7 shows a flow chart for the control system. Once rotary encoders are connected, and initial positions are determined, the servo motors for each airfoil adjust to desired angles of attack. As the armatures begin to orbit, information on orbital rotation is fed back to the control system along with current wind direction, to reset the angles of attack for the airfoils.

The feedback from rotatory encoders on the wind vane, main axle, and airfoils continue with additional feedback from the generator. If the angle of attack is increased so that it is too steep, and starts producing drag, the inefficiency will slow orbital rotation and decrease power generation, signaling a need to decrease the optimal angle of attack.

Although the present invention has been described in specific embodiments, additional modifications and variations would be apparent to a person of ordinary skill in the art. The present embodiments of the invention should he considered in all respects as illustrative, rather than restrictive, and the scope of the invention determined by the claims supported by this application and their equivalents.

What is claimed is:

1. A vertical axis turbine for converting the energy of a moving fluid into mechanical energy, the turbine comprising:
A means for determining the direction of moving fluid;
A central axle;
A means for measuring the rotation of the central axle;
At least three camber-less symmetrical foils with a leading edge and a trailing edge;
A means of connecting the at least three camber-less symmetrical foils to a central axle;
An axle at the center of lift for each foil;
A means for rotating each foil about its axle at the center of lift;
A means for measuring the rotation of each foil about its axle at the center of lift;
Wherein a control system continuously positions the leading edges of each foil into the moving fluid, using the measurements of fluid direction, rotation of the central axle, and rotations of the foils about their respective axles at their centers of lift.

2. The turbine of claim I, wherein the control system positions the foils at angles of attack to the moving fluid, turning the central axle and generating a rotational force on the turbine.

3. The turbine of claim 2, wherein there are two power zones, a forward power zone and a leeward power zone, and the angle of attack in the forward power zone is reversed in the leeward power zone, such that rotational forces in both zones generate a coordinated rotational force.

4. The turbine of claim 3, wherein the rotational force is clockwise.

5. The turbine of claim 3, wherein the rotational force is counterclockwise.

6. The turbine of claim 3, wherein the control system positions the foils to an angle of attack parallel to the direction of moving fluid as the foils transition between forward and leeward power zones, minimizing both lift and drag.

7. The turbine of claim 3, wherein the control system positions the foils in the forward and leeward power zones at increased angles of attack, to increase rotational forces.

8. The turbine of claim 3, wherein the control system positions the foils in the forward and leeward power zones at decreased angles of attack, to decrease rotational forces.

9. The turbine of claim 1, wherein the control system positions the foils to a stopped mode, such that the foils are parallel to the direction of the moving fluid, minimizing both lift and drag and generating no rotational forces on the turbine.

10. The turbine of claim 1, wherein the main axle is connected to an electrical power generator, converting the mechanical energy into electrical power.

11. The turbine of claim 1, wherein the means for determining the direction of the moving fluid is connected to central axle,

12. The turbine of claim 1, wherein the means for determining the direction of the moving fluid is located proximate to the turbine

13. The turbine of claim 1, wherein the means for determining the direction of the moving fluid is also the means for measuring the rotation of the central axle, such that the measurement of rotation of the central axle is differential to the direction of moving fluid.

14. The turbine of claim 1, wherein pairs of armatures are the means of connecting the foils to the central axle.

15. The turbine of claim 1, wherein the means of rotating each foil about is axle at the center of lift, is a servo motor.

16. The turbine of claim 1, wherein the means of rotating each foil about is axle at the center of lift, is a stepper motor.

17. The turbine of claim 1, wherein the means of measuring the rotation of each foil about its axle at the center of lift is an absolute rotary encoder.

18. The turbine of claim 1, wherein the means of measuring the rotation of each foil about its axle at the center of lift is a rotary encoder coupled with a home sensor.
